(19) United States
(12) Patent Application Publication
(10) Pub. No.: US 2010/0222458 A1
(43) Pub. Date: Sep. 2, 2010

(54) COMPOSITIONS AND PROCESSING METHODS OF ENVIRONMENTAL-FRIENDLY MULTIPLE-EFFECT POWDER

(76) Inventors: Wu-Tian Wang, Sanxia Town (TW); Wu-Ching Wang, Taipei City (TW); Mei-Yu Huang Wang, Sanxia Town (TW); Shiau-Ming Wang, Sanxia Town (TW); Shiau-Hau Wang, Sanxia Town (TW); Shi-Cheng Huang, Kaohsiung City (TW); Chen Hong, Taichung City (TW); Teng-Ki Lin, Madou Town (TW)

Correspondence Address: EGBERT LAW OFFICES, 412 MAIN STREET, 7TH FLOOR, HOUSTON, TX, 77002, US

(21) Appl. No.: 12/396,371

(22) Filed: Mar. 2, 2009

(51) Int. Cl. C04B 24/24; C04B 24/02; C04B 28/00

(52) U.S. Cl. 524/6; 524/2

(57) ABSTRACT

The present invention provides the compositions and processing methods of an environmental-friendly, multiple-effect powder. The compositions of environmental-friendly, multiple-effect powder include: cement, discarded PCB powder, resin, wasted coating powder and volcano mud powder. The environmental-friendly, multiple-effect powder of the present invention can also be widely applied to civil works as a coating/filling material or other composite building materials due to its advantages such as good thermal insulation, noise absorption, water-proofing, resistance to mildew, rustiness and acid/alkali, excellent robustness and moisture retention with better industrial and economic benefits.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to the compositions and processing methods of a powder, and more particularly to an environmental-friendly one which is composed of cement, discarded polychlorinated biphenyl (PCB) powder, resin, wasted coating powder and volcano mud powder.

2. Description of Related Art Including Information Disclosed Under 37 CFR 1.97 and 37 CFR 1.98

With ongoing scientific progress, the human environment is more vulnerable to various pollutions, so environmental protection raises worldwide concern since the human beings will meet the biggest moral challenges in the new century.

However, the serious damage of hi-tech chemicals against the ecological environment of the Earth is often neglected when the human beings live a modern life based on technological civilization. Thus, it is essential to consider how to save the energy sources, recycle the resources and transform the toxic wastes into high-performance substances in an environmental-friendly, cost-effective manner, thereby reducing the impact on the human beings and environment. This will inevitably lead to an environmental revolution in the predictable future.

Coupling with fast-changing information flow in the modern era, new technological products, such as computers, household appliances, mobile phones, industrial instruments, automated equipments, vehicles, aviation and aerospace devices, are closely related to electronic products. As an important base plate of electronic products, PCB serves as its functional carrier and grows quickly under ever-growing competition and innovation. Hence, there are serious wastes.

People create a great amount of products by substantial oil extraction and refining of resin, leading not only to an oil crisis but also defective products and wastes. So, there are many marketing opportunities if electronic wastes can be effectively recycled and reused. The printed circuit boards are made of epoxy resin, phenolic resin, phenolic moulding powder, fire-resistant fibers, heavy metals and multiple chemicals, presenting strong pH resistance to decomposition. If waste PCBs are disposed by landfill or if the boring powder is dumped into brooks and rivers, the harmful substances will surely lead to material damage to the ecological environment. Air pollution will be caused to endanger human health if a combustion method is employed.

At present, many products are coated with powder during the manufacturing process. Since the misty resin powder sprayed to electrostatic products during the coating process cannot be fully absorbed onto the workpieces, some waste resin powder containing resin will be accumulated at the bottom of the coating chamber. If such powder is disposed as a waste, either by landfill or combustion, pollution will surely occur, resulting in substantial waste of resources in the absence of recycling channel and purpose.

In recent years, global warming is caused by the greenhouse effect arising from carbon dioxide. Meanwhile natural disasters, volcanic eruptions, earthquakes and tsunamis occur more frequently. Some low-lying cities or island countries face the risk of rising sea level and subsequent submersion. Rampant diseases, acid rain erosion and natural ecological destruction, etc., endanger the survival of the human beings and other animals and plants, so the world is meeting the challenge of global warming as the third world war.

Despite of the scientific achievements made by the human beings, it is critical to prevent the possible catastrophe arising from scientific advancement. In this regard, everyone in the global village shall make its own effort to establish a green energy structure and carry out the environmental protection and clean energy utilization plan, so as to minimize the impact on the global environment.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

1. Environmental Protection Due to Waste Recycling:

The discarded PCB powder and wasted coating powder contained in the environmental-friendly, multiple-effect powder of the present invention can be recycled as industrial waste. With the flourishing development of electronic products, there is an unbelievable amount of discarded PCB powder and wasted coating powder, leading to serious environmental problems and wide-ranging social concern. As the environmental-friendly, multiple-effect powder of the present invention is widely applied to civil works and other construction projects, numerous discarded PCB powder and wasted coating powder can thus be recycled and reutilized. As a raw material in a volcanic environment, the volcano mud cannot yet be put into commercial use, or used for planting purposes due to its solid property, resulting in water pollution and ecological destruction. In the present invention, a large amount of volcano mud can be recycled to reduce its threat on the surrounding agricultural environment and prevent water pollution and ecological disaster.

2. Strong Water-Proofing and Fungi-Proofing for the Users:

Based on the innovation of the present invention, environmental-friendly, multiple-effect powder contains discarded PCB powder. It is possible to reduce substantially water permeability and cut down the water repellent admixture since the resin of tiny molecules in the discarded PCB powder can be filled into the gap between the cement mortar. Moreover, the discarded PCB powder also contains acid/alkali-resisting contents since PCB must be subject to acid/alkali-resisting treatment. With such advantages and effects, the environmental-friendly, multiple-effect powder can be used as a wall coating material to protect the buildings against acid/alkali corrosion, rustiness and weathering, thereby extending the service life of the buildings.

3. Structural Robustness:

Based on the innovation of the present invention, the environmental-friendly, multiple-effect powder contains discarded PCB powder, wasted coating powder and volcano mud powder. The resin of tiny molecules in the discarded PCB powder and wasted coating powder as well as the fine-structure volcano mud powder can be filled into the gap between the cement mortar, thus improving greatly the compactness of the structure and binding strength of the aggregate while enhancing the adhesion effect of cement without looseness and bulging. Meanwhile, the environmental-friendly, multiple-effect powder features light-weight and ease for construction due to the lightweight discarded PCB powder and wasted coating powder.

4. Moisture Retention Effect:

Since both discarded PCB powder and wasted coating powder of the environmental-friendly, multiple-effect powder contain resin powder of non-absorbency, it is feasible to reduce the water consumption, improve the bleeding phenomenon of cement mortar and provide excellent workability by extremely low water cement ratio. Namely, the multiple-effect powder of the present invention can mitigate efficiently the condensation of cement, and prevent the cracking phenomenon arising from rapid hardening and drying shrinkage of cement, thus overcoming non-performing construction and curing problems for optimized physico-chemical property.

5. Catalytic Expansion Effect:

The discarded PCB powder of the environmental-friendly, multiple-effect powder of the present invention contains aluminum components (note: aluminum components refer to the residues from the PCB. This is because an aluminum plate is often placed on the surface of the PCB, and some scraps of aluminum plate are brought into the hole of PCB during the drilling process), so it is possible to improve the aquation of cement, mitigate the depression and cracking of cement arising from its rapid hardening, and then generate a catalytic expansion effect to further enhance the coating levelness and construction efficiency.

6. Strong Resistance to Temperature, Heat, Combustion, Fire and UV-Light:

The cement and volcano mud powder contained in the environmental-friendly, multiple-effect powder are fire-resistant, while the discarded PCB powder, resin, wasted coating powder, volcano mud and cement are not combustion-supporting after hardening, so the environmental-friendly, multiple-effect powder of the present invention can be used as an ideal fireproofing building material (plate, block or paint). Moreover, the wasted coating powder is UV-resistant.

7. Better Industrial and Economic Benefits:

The discarded PCB powder, wasted coating powder and volcano mud powder contained in the environmental-friendly, multiple-effect powder can be recycled with a much lower cost, and the discarded PCB powder is processed by traditional cutting, stirring and segregating equipment. So, the processing cost can be minimized for the benefit of the manufacturers and customers. The wasted coating powder also contains resin, so the consumption and cost of resin can be reduced. The wasted coating powder with multiple colors is conducive to the color representation of environmental-friendly, multiple-effect powder with better industrial and economic benefits.

The compositions of the environmental-friendly, multiple-effect powder of the present invention along with the heat-insulating materials features energy conservation, lower noise interference, strong water-proofing, fire-proofing and fungi-proofing as well as excellent resistance to acid/alkali corrosion, rustiness and weathering, so it can help build up environmental-friendly buildings and create a healthy and comfortable living environment.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a flow chart of the compositions of environmental-friendly, multiple-effect powder of the present invention.

FIG. 2 shows a flow chart of the manufacturing method of environmental-friendly, multiple-effect powder of the present invention.

FIG. 3 shows a schematic view of the first application view of the present invention.

FIG. 4 shows another schematic view of the second application view of the present invention.

FIG. 5 shows a schematic view of the third application view of the present invention.

### DETAILED DESCRIPTION OF THE INVENTION

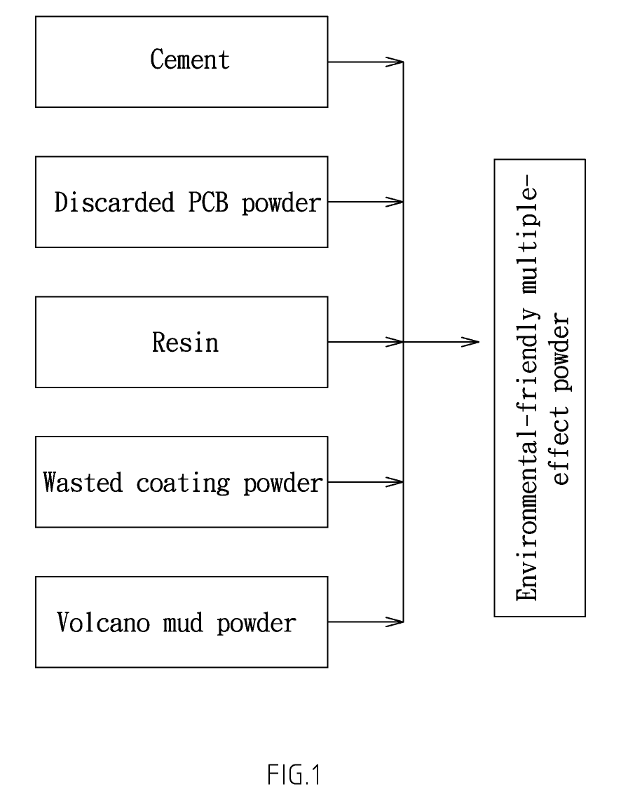

FIG. 1 depicts a preferred embodiment of the compositions and processing methods of environmental-friendly, multiple-effect powder of the present invention. These embodiments are only provided for explanatory purposes with respect to the patent claims.

The environmental-friendly, multiple-effect powder comprises cement, discarded PCB powder, resin, wasted coating powder and volcano mud powder.

The discarded PCB powder contains phenolic resin, epoxy resin, glass fiber and aluminum.

If the gross weight of the multiple-effect powder is considered as 100%, the cement, discarded PCB powder, resin, wasted coating powder and volcano mud powder accounts for 10-50%, respectively, within which this composition can be adjusted where necessary.

The grain size of the volcano mud powder ranges between 100-500 nm.

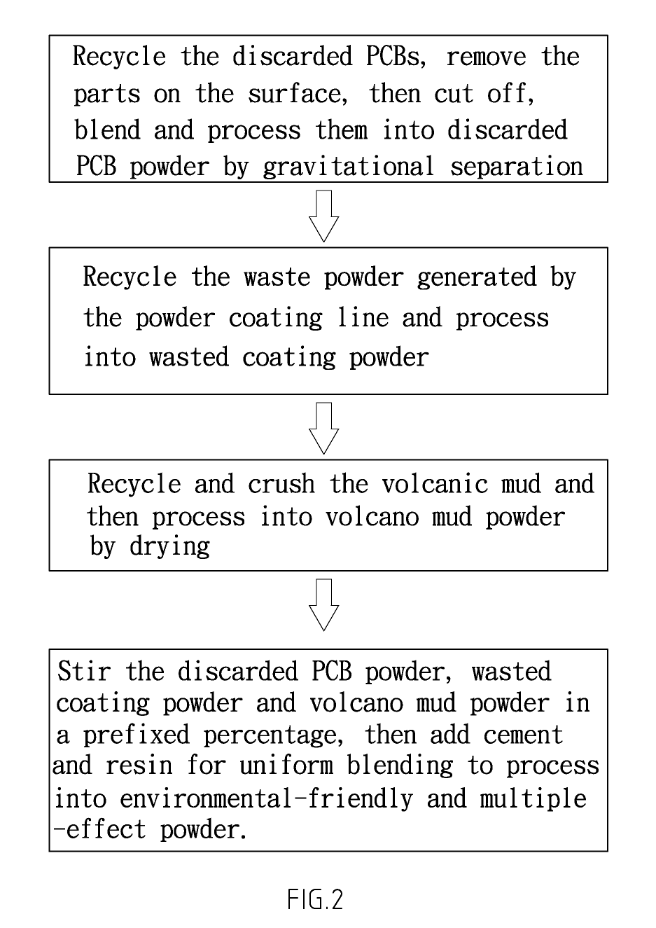

The compositions of the environmental-friendly, multiple-effect powder of the present invention are processed by the following ways: (shown in FIG. 2)

(a) Recycle the discarded PCBs, remove the parts on the surface, then cut off, blend and process them into discarded PCB powder by gravitational separation;

(b) Recycle the waste powder generated by the powder coating line and process into wasted coating powder;

(c) Recycle and crush the volcanic mud and then process into volcano mud powder by drying;

(d) Stir the discarded PCB powder, wasted coating powder and volcano mud powder in a prefixed percentage, then add cement and resin for uniform blending to process into environmental-friendly and multiple-effect powder.

Prior to aforementioned stirring, the volcano mud powder can be blended with the powdery resin or liquid resin and then stored, thus eliminating the drying process, preventing solidification and reducing the production cost during the storing process.

The present invention is applied as follows:

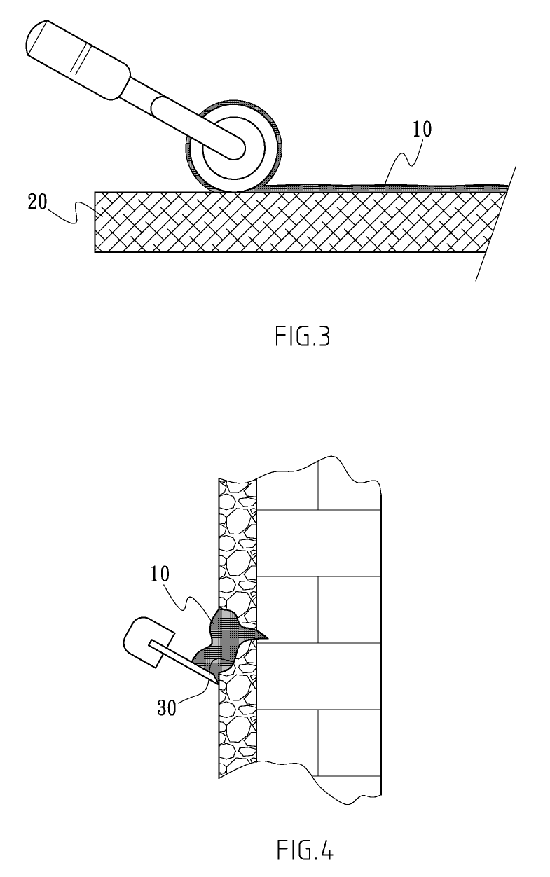

Referring to FIG. 3, the environmental-friendly, multiple-effect powder 10 can be processed into a coating mixture by means of liquid mixing, and then applied to the building or a building material 20 (e.g. plates, laminated cloth (leather), compound materials) by means of spraying or brush coating, thus improving the physico-chemical properties.

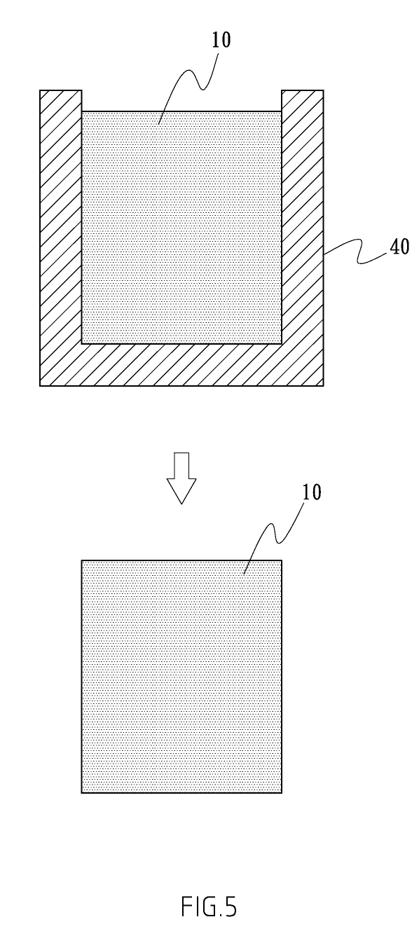

Referring to FIG. 4, the environmental-friendly, multiple-effect powder 10 can also be used as a filling material to fill in the gap 30 between cement and sandstone. In such a case, it becomes a high-quality protecting wall structure featuring good adherence, robustness and compactness as well as strong pH resistance, antisepsis and thermal insulation.

Referring to FIG. 5, the environmental-friendly, multiple-effect powder 10 can also be used as a moulding material by means of liquid mixing, that's to say, a mould 40 (or interlayed space) is preset, then the environmental-friendly, multiple-effect powder 10 in liquid state is poured into the mould 40 (or interlayed space). The dried environmental-friendly, multiple-effect powder 10 is demoulded into a 3D structure such as: columns, pipes, wave plates and tiles. In addition, the environmental-friendly, multiple-effect powder 10 can be fabricated by hot-pressing, rolling or drying from the combinations of mats, hemp nets, glass fiber nets, coconut tissues, straws and non-woven fabric, etc. Moreover, a daylight effect can be obtained from the structural clearance of such innovative, environmental-friendly and thermally insulating wave plates or building materials.

Alternatively, the environmental-friendly, multiple-effect powder 10 of the present invention can replace the existing metal wave plates, tiles, stones, timbers, ceramics, plastic boards (leathers), concrete, EPS, PS board, PV and PE as well as conventional protective paints. It can also be processed into pseudo-stones, pseudo-timbers and pseudo-ceramics with improved performance, for instance, the shortcomings of metal wave plates include: structural thinness, noise from rainfall, lower resistance to acid and alkali, vulnerability to rustiness and leakage, higher heat conductivity, poorer heat insulation, aging and deformation. The shortcomings of stone include: bulky volume, higher transportation cost, difficulty for construction, higher heat conductivity, poorer heat insulation and water-proofing as well as vulnerability to breakage or falling during fire hazard or earthquake; the shortcomings of timber lie in water/fire hazards and white ants; and formaldehyde added during fabrication process will possibly lead to cancer. The shortcomings of ceramic include: time-consuming construction, higher heat conductivity and poorer heat insulation, fragility to collision, vulnerability to falling, contamination and water leakage. The shortcomings of plastics are not environmental-friendly, non-refractory and liable to deformation. The shortcomings of conventional protective paints lie in solvents and formaldehyde not environmental-friendly, excessively high percentage of antirust heavy metals and higher cost. The environmental-friendly, multiple-effect powder 10 of the present invention thus becomes a new-generation of building material due to the following advantages and characteristics.

1. A composition of an environmental-friendly, multiple-effect powder, said composition comprising:
cement, discarded PCB powder, resin, wasted coating powder and volcano mud powder.

2. The composition defined in claim 1, wherein the discarded PCB powder is comprised of phenolic resin, epoxy resin, glass fiber and aluminum.

3. The composition defined in claim 1, wherein the gross weight of multiple-effect powder is considered as 100%, the cement, discarded PCB powder, resin, wasted coating powder and volcano mud powder accounts for 10˜50%, respectively, of multiple-effect powder.

4. The composition defined in claim 1, wherein the volcano mud powder has a grain size ranging between 100˜500 nm.

5. The method of forming the composition defined in claim 1, the composition being environmental-friendly, and having multiple-effects, the method comprising the steps of:
recycling discarded PCBs by removing parts on the surface, then cut off, stir and process them into discarded PCB powder by gravitational separation;
recycling waste powder generated by the powder coating line and process into wasted coating powder;
recycling and crushing volcanic mud and then process into volcano mud powder by drying; and
stir the discarded PCB powder, wasted coating powder and volcano mud powder in a prefixed percentage, then add cement and resin for uniform blending to process into environmental-friendly and multiple-effect powder.

6. The method defined in claim 5, wherein the volcano mud powder blends with the resin before mixture and stirring, thus preventing solidification during the storing process.
